(19) United States
(12) Patent Application Publication
(10) Pub. No.: US 2026/0323069 A1
(43) Pub. Date: Oct. 15, 2026

(54) METHOD AND APPARATUS FOR VIDEO CODING USING LOCAL ILLUMINATION COMPENSATION IN AFFINE MODEL-BASED PREDICTION

(71) Applicants: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(72) Inventors: Sea Nae Park, Seoul (KR); Jong Seok Lee, Seoul (KR); Dong Gyu Sim, Seoul (KR); Jin Heo, Yongin-si (KR); Jung Ah Choi, Seoul (KR); Seung Wook Park, Yongin-si (KR)

(73) Assignees: HYUNDAI MOTOR COMPANY, Seoul (KR); KIA CORPORATION, Seoul (KR); KWANGWOON UNIVERSITY INDUSTRY-ACADEMIC COLLABORATION FOUNDATION, Seoul (KR)

(21) Appl. No.: 19/484,061

(22) PCT Filed: Mar. 19, 2024
(86) PCT No.: PCT/KR2024/003431

§ 371 Date: Nov. 13, 2025

(30) Foreign Application Priority Data
May 16, 2023 (KR) 10-2023-0063322
Mar. 18, 2024 (KR) 10-2024-0037141

(51) Int. Cl. H04N 19/513; H04N 19/176; H04N 19/82

(52) U.S. Cl. CPC H04N 19/513; H04N 19/176; H04N 19/82

(57) ABSTRACT

A video decoding apparatus generates, by using the shape of the affine model and the control point motion vectors, motion vectors of subblocks partitioned from the current block. The apparatus generates a reference block of the current block by deriving sub-reference blocks of the subblocks by using the motion vectors. When the neighboring reference pixels of the current block are available, the video decoding apparatus calculates, related to top sub-reference blocks and left sub-reference blocks of the reference block, positions of neighboring reference pixels of each top or left sub-reference block. When the neighboring reference pixels of the reference block are available in the calculated positions, the apparatus derives parameters of a linear relation between the neighboring reference pixels of the current block and the neighboring reference pixels of the reference block and generates a prediction block of the current block by applying local illumination compensation to the reference block.

### TECHNICAL FIELD

The present disclosure relates to a video coding method and an apparatus using local illumination compensation in an affine mode-based prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

To improve the prediction efficiency of inter prediction, a method of compensating for the illumination of the decoded image based on the reference image may be applied. The decoder uses the neighboring pixels of the reference block and the neighboring pixels of the current block to derive the local illumination variation between the reference block and the current block, and then applies the derived relationship to the reference block and thereby performs local illumination compensation (LIC) for the current block. Meanwhile, to improve video coding efficiency and video quality, there is a need for a method of applying the above-described local illumination compensation to affine model-based prediction.

### DISCLOSURE

### Technical Problem

The present disclosure seeks to provide a video coding method and an apparatus that, when predicting a current block in subblock units based on an affine model, derive a linear relation between the neighboring reference pixels of the current block and the neighboring reference pixels of the reference block, and use the linear relation to apply local illumination compensation to the reference block.

### Technical Solution

At least one aspect of the present disclosure provides a method of reconstructing a current block by a video decoding apparatus. The method includes obtaining a shape of an affine model of the current block and deriving control point motion vectors. The method also includes generating, by using the shape of the affine model and the control point motion vectors, motion vectors of subblocks partitioned from the current block. The method also includes generating a reference block of the current block by deriving sub-reference blocks of the subblocks by using the motion vectors. The method also includes checking availability of neighboring reference pixels of the current block at a top side and a left side of the current block. When the neighboring reference pixels of the current block are available, the method further includes calculating, related to top sub-reference blocks and left sub-reference blocks of the reference block, positions of neighboring reference pixels of each top or left sub-reference block. The method further includes checking availability of neighboring reference pixels of the reference block by checking availability, at the positions calculated, of the neighboring reference pixels of each top or left sub-reference block. When the neighboring reference pixels of the reference block are available in whole or in part, the method further includes deriving parameters of a linear relation between the neighboring reference pixels of the current block and the neighboring reference pixels of the reference block. The method further includes generating a prediction block of the current block by applying local illumination compensation to the reference block by using the parameters of the linear relation.

Another aspect of the present disclosure provides a method of encoding a current block by a video encoding apparatus. The method includes determining a shape of an affine model of the current block and deriving control point motion vectors. The method also includes generating, by using the affine model and the control point motion vectors, motion vectors of subblocks partitioned from the current block. The method also includes generating a reference block of the current block by deriving sub-reference blocks of the subblocks by using the motion vectors. The method also includes checking availability of neighboring reference pixels of the current block at a top side and a left side of the current block. When the neighboring reference pixels of the current block are available, the method further includes calculating, related to top sub-reference blocks and left sub-reference blocks of the reference block, positions of neighboring reference pixels of each top or left sub-reference block. The method further includes checking availability of neighboring reference pixels of the reference block by checking availability, at the positions calculated, of the neighboring reference pixels of each top or left sub-reference block. When the neighboring reference pixels of the reference block are available in whole or in part, the method further includes deriving parameters of a linear relation between the neighboring reference pixels of the current block and the neighboring reference pixels of the reference block. The method further includes generating a first prediction block of the current block by applying local illumination compensation to the reference block by using the parameters of the linear relation.

Yet another aspect of the present disclosure provides a computer-readable recording medium storing a bitstream generated by a video encoding method. The video encoding method includes determining a shape of an affine model of a current block and deriving control point motion vectors. The video encoding method also includes generating, by using the affine model and the control point motion vectors, motion vectors of subblocks partitioned from the current block. The video encoding method also includes generating a reference block of the current block by deriving sub-reference blocks of the subblocks by using the motion vectors. The video encoding method also includes checking availability of neighboring reference pixels of the current block at a top side and a left side of the current block. When the neighboring reference pixels of the current block are available, the video encoding method further includes calculating, related to top sub-reference blocks and left sub-reference blocks of the reference block, positions of neighboring reference pixels of each top or left sub-reference block. The video encoding method further includes checking availability of neighboring reference pixels of the reference block by checking availability, at the positions calculated, of the neighboring reference pixels of each top or left sub-reference block. When the neighboring reference pixels of the reference block are available in whole or in part, the video encoding method further includes deriving parameters of a linear relation between the neighboring reference pixels of the current block and the neighboring reference pixels of the reference block. The video encoding method further includes generating a prediction block of the current block by applying local illumination compensation to the reference block by using the parameters of the linear relation.

### Advantageous Effects

As described above, the present disclosure provides a video coding method and an apparatus that, when predicting a current block in subblock units based on an affine model, derive a linear relation between the neighboring reference pixels of the current block and the neighboring reference pixels of the reference block, and use the linear relation to apply local illumination compensation to the reference block. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the pixel-wise calculation of an affine model, according to at least one embodiment of the present disclosure.

FIG. 7 is a diagram illustrating the calculation of an affine model by using a center vector, according to at least one embodiment of the present disclosure.

FIG. 8 is a diagram illustrating the subblock-wise calculation of an affine model, according to at least one embodiment of the present disclosure.

FIG. 9 is a diagram of an example local illumination compensation.

FIG. 10 is a diagram of other example local illumination compensations.

FIG. 11 is a diagram illustrating local illumination compensation in affine model-based prediction, according to at least one embodiment of the present disclosure.

FIG. 12 is a diagram illustrating neighboring reference pixels used for local illumination compensation, according to at least one embodiment of the present disclosure.

FIG. 13 is a flowchart of a method of encoding a current block by a video encoding apparatus, according to at least one embodiment of the present disclosure.

FIG. 14 is a diagram illustrating neighboring reference pixels used for local illumination compensation, according to another embodiment of the present disclosure.

FIG. 15 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

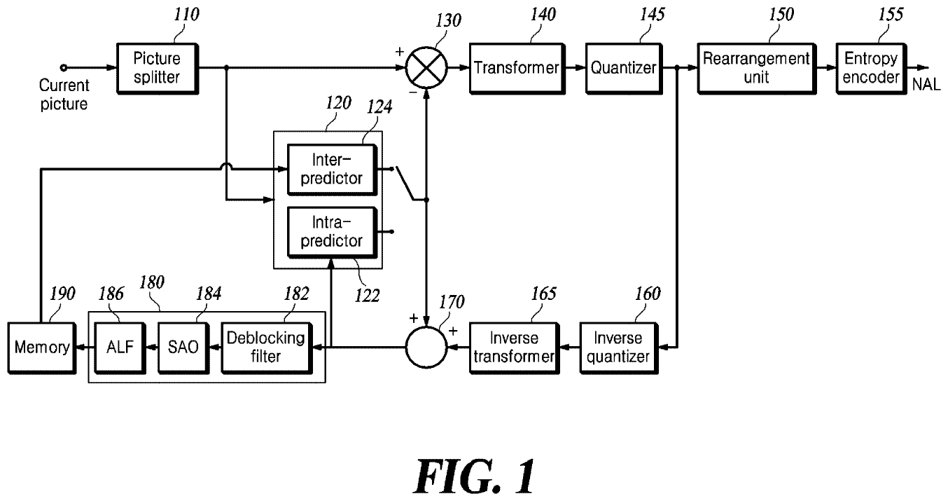

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a ternarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree ternarytree (QTBTTT) structure may be used. Here, a binarytree ternarytree (BTTT) is added to the tree structures to be referred to as a multiple-type tree (MTT).

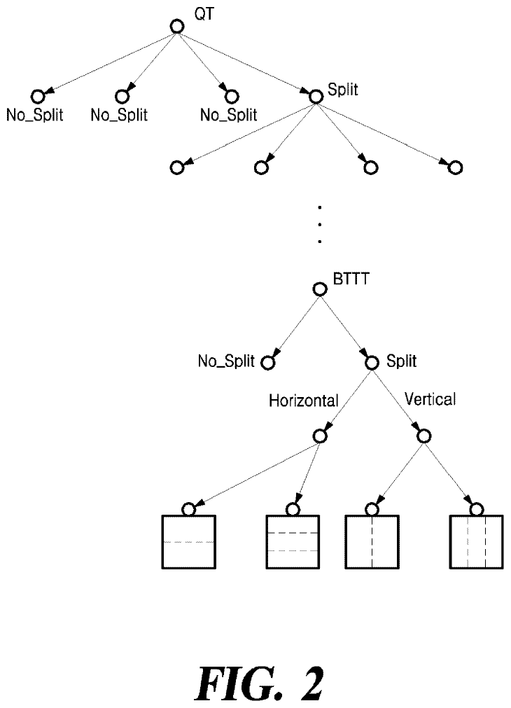

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

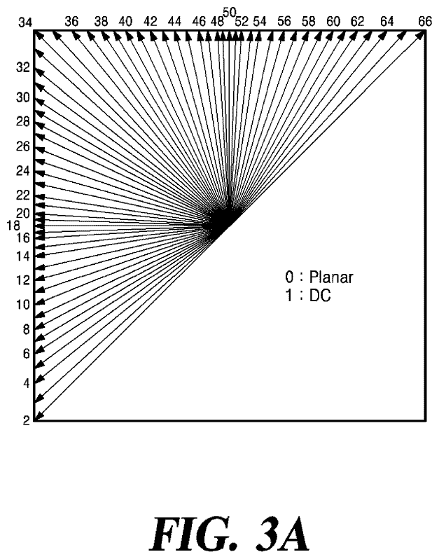

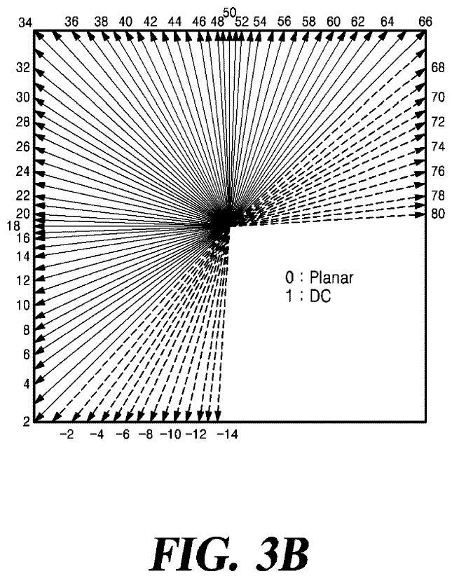

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (intra prediction modes #67 to #80, #-1 to #-14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than-135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

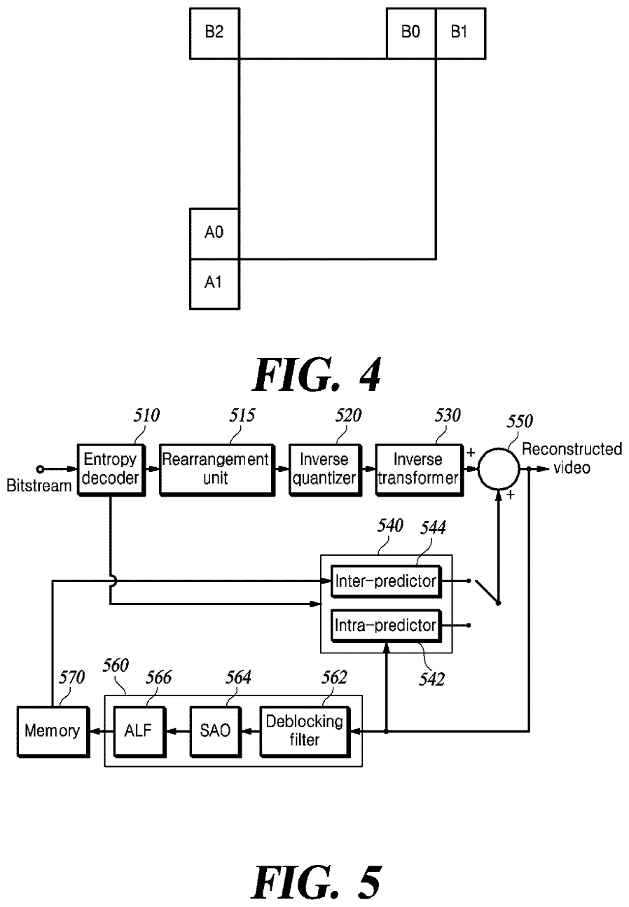

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510, and predicts the current block by using the motion vector and the reference picture.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus apparatuses that, when predicting the current block in subblock units based on an affine model, derive a linear relation between the neighboring reference pixels of the current block and the neighboring reference pixels of the reference block, and use the linear relation to apply local illumination compensation to the reference block.

The following embodiments may be performed by the inter predictor 124 in the video encoding device. The following embodiments may also be performed by the inter predictor 544 in the video decoding device.

The video encoding device in encoding the current block may generate signaling information associated with the present embodiments in terms of optimizing rate distortion.

The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Affine Model-Based Prediction

As a measure of improving encoding/decoding efficiency, an affine model is responsive to object signals or background signals in a video, which have changed due to the movement of cameras or objects in the spatial-temporal domain for deriving and modeling the signals' geometric relationship and then applying the modeled relationship to a reference signal and an original signal. In theory, if one perfectly derives the relationship representing the 3D affine model about the same object, the one could use the relationship for a perfect prediction. However, such a perfect prediction is only attainable in theory. In video coding, prediction errors can be compensated by using prediction signals predicted based on the modeling and using difference signals. The affine model-based prediction method has the effect of increasing coding efficiency by relying on improved prediction accuracy, but it also badly increases the computational complexity required to calculate the affine model.

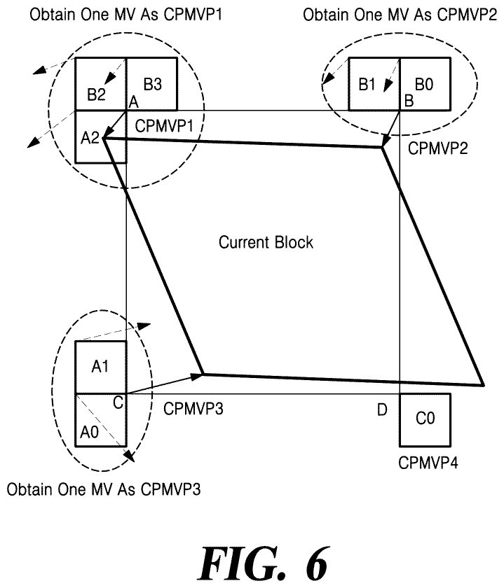

FIG. 6 is a diagram illustrating the pixel-wise calculation of an affine model, according to at least one embodiment of the present disclosure.

To reduce computational complexity, in the embodiment of FIG. 6, one utilizes the probability that the current block and neighboring blocks have the same or similar pixel values and motion information. The video decoding apparatus uses the motion vector of the adjacent block to the positions corresponding to the corner points A, B, and C of the current block to predict the corresponding control point motion vectors (CPMVs). The video decoding apparatus uses the control point motion vectors to perform modeling of the geometric transform relationship between the current block and the prediction block, i.e., the affine model, and then performs prediction of the current block based on the modeled transform relationship. The illustration of FIG. 6 presents a 6-parameter affine model using the control point motion vectors at the three points A, B, and C, but some embodiments may use a 4-parameter affine model using the control point motion vectors at two points A and B or A and C. Depending on the 4-parameter affine model or 6-parameter affine model, the motion vectors (mvₓ, mv_{y}) at the target block (x, y) pixels may be expressed by using the control point motion vectors and the pixels' positions, respectively, as shown in Equation 1 and Equation 2.

$$\{ \begin{matrix}{mv}_{x} = \frac{{cpmv}_{2 x} - {cpmv}_{1 x}}{W} x - \frac{{cpmv}_{2 y} - {cpmv}_{1 y}}{W} y + {cpmv}_{1 x} \\ {mv}_{y} = \frac{{cpmv}_{2 y} - {cpmv}_{1 y}}{W} x + \frac{{cpmv}_{2 x} - {cpmv}_{1 x}}{W} y + {cpmv}_{1 y}\end{matrix} \qquad [ Equation 1 ]$$

$$\{ \begin{matrix}{mv}_{x} = \frac{{cpmv}_{2 x} - {cpmv}_{1 x}}{W} x + \frac{{cpmv}_{3 x} - {cpmv}_{1 x}}{H} y + {cpmv}_{1 x} \\ {mv}_{y} = \frac{{cpmv}_{2 y} - {cpmv}_{1 y}}{W} x + \frac{{cpmv}_{3 y} - {cpmv}_{1 y}}{H} y + {cpmv}_{1 y}\end{matrix} \qquad [ Equation 2 ]$$

Here, W and H are the width and height of the current block. (cpmvᵢₓ, cpm_{viy}) is the i-th control point motion vector. The predicted values for the respective pixels of the current block may be produced by using the motion vectors calculated according to Equation 1 or Equation 2. Although not included in the affine model, as illustrated in FIG. 6, CPMVP4 may be defined for position D. Since position D is a pixel that has not yet been reconstructed, the motion vector of the co-located pixel in the reference picture may be used in place of CPMVP4.

In the example of FIG. 6, CPMVP represents the control point motion vector predictor in an affine AMVP mode. In an affine merge mode, since the motion vector difference (MVD) is not transmitted, CPMVP is the same as CPMV. In the affine AMVP mode, since the motion vector difference is transmitted, CPMV may be calculated by summing CPMVP and MVD. FIG. 6 illustrates using a combination or construction among methods of generating a control point motion vector predictor in the affine AMVP mode. The affine merge mode and affine AMVP mode are described below.

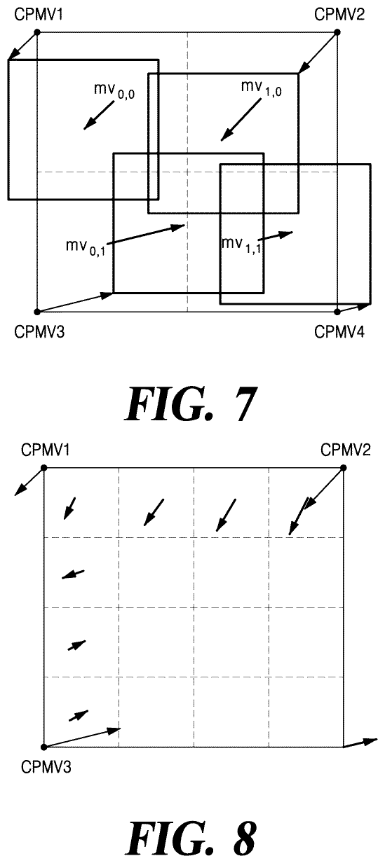

FIG. 7 is an example illustrating the calculation of an affine model by using a center vector, according to at least one embodiment of the present disclosure.

Additionally, to reduce computational complexity in some embodiments, the video decoding apparatus may perform block-based prediction by using each control point motion vector for the center vector, as illustrated in FIG. 7. In this case, assuming that the current block has four control point motion vectors, the current block may be partitioned into four blocks. In the method illustrated in FIG. 7, blocks using each control point motion vector as the center vector may be predicted according to the same motion vector. Although this may have a lower prediction accuracy than the pixel-wise calculation embodiment, it can reduce the computational complexity.

FIG. 8 is a diagram illustrating the subblock-wise calculation of an affine model, according to at least one embodiment of the present disclosure.

As an example, to reduce computational complexity, the video decoding apparatus may perform prediction in subblock unit, as illustrated in FIG. 8. If the width or height of the current block is larger than the width or height of the subblock, the video decoding apparatus may partition the current block into subblocks. The video decoding apparatus uses the control point motion vectors of the current block to derive the control point motion vectors at the respective corner point positions of the subblocks, and then derives a representative motion vector from among the control point motion vectors of each subblock. The video decoding apparatus uses the derived representative motion vector to generate a prediction block for each subblock, and then combines the prediction blocks in subblock units to generate a first prediction block of the current block.

In another example, the video decoding apparatus calculates the motion vector of each subblock by substituting the center position of each subblock into (x, y) in Equation 1 or Equation 2. Here, the center position may be the actual center point of the subblock or the bottom-right sample position of the center point. For example, with a 4×4 subblock whose top-left sample coordinates are (0,0), the center position of the subblock may be (1.5,1.5) or (2,2). The video decoding apparatus uses the derived motion vector to generate a prediction block for each subblock, and then combines the subblock-level prediction blocks to generate the first prediction block of the current block.

In some embodiments, the video decoding apparatus may filter the first prediction block to generate a second prediction block. Thereafter, the video decoding apparatus may generate the final prediction block of the current block by using one of the first prediction block and the second prediction block.

To reduce the amount of bits required to encode the control point motion vectors, the above-described regular method of inter prediction (translational motion prediction) method, i.e., the affine merge mode and the affine AMVP mode, may be applied. Hereinafter, the affine merge mode and affine AMVP mode are referred to as control point motion vector prediction methods.

In one example, when in the affine merge mode, the inter predictor 124 of the video encoding apparatus organizes a predefined number of (e.g., 5) affine merge candidate lists. First, the video encoding apparatus derives inherited affine merge candidates from the neighboring blocks of the target block. For example, by deriving a predefined number of inherited affine merge candidates from the neighboring samples A0, A1, B0, B1, and B2 of the target block shown in FIG. 4, a merge candidate list is generated. Each of the inherited affine merge candidates in the candidate list corresponds to a combination of two or three CPMVs (control point motion vectors).

The video encoding apparatus derives the inherited affine merge candidates from control point motion vectors of the target block's neighboring blocks that are predicted in affine mode. Some embodiments may limit the number of merge candidates derived from the neighboring blocks predicted in affine mode. For example, the video encoding apparatus may derive from the neighboring blocks predicted in affine mode, two inherited affine merge candidates, one of A0 and A1, and one of B0, B1, and B2. The prioritization may be in the order of A0, A1, and then the order of B0, B1, and B2.

On the other hand, if the total number of merge candidates is more than three, the video encoding apparatus may derive the required number of supplementary constructed affine merge candidates from the translational motion vectors of the neighboring blocks, as illustrated in FIG. 6.

The video encoding apparatus derives control point motion vectors CPMV1, CPMV2, and CPMV3 each from neighboring blocks group {B2, B3, A2}, neighboring blocks group {B1, B0}, and neighboring blocks group {A1, A0}. As one example, the prioritization within each neighboring block group may be in the order of B2, B3, and A2, the order of B1 and B0, and the order of A1 and A0. A further control point motion vector CPMV4 is derived from the co-located block in the reference picture. The video encoding apparatus combines two or three control point motion vectors out of the four control point motion vectors to generate the required number of supplementary constructed affine merge candidates. The prioritization of the combinations is as follows. The elements within the respective groups are listed in the following order: control point motion vectors at the top-left corner, top-right corner, and then bottom-left corner.

{CPMV1, CPMV2, CPMV3}, {CPMV1, CPMV2, CPMV4}, {CPMV1, CPMV3, CPMV4},

{CPMV2, CPMV3, CPMV4}, {CPMV1, CPMV2}, {CPMV1, CPMV3}

If the merge candidate list cannot be filled up by using the inherited affine merge candidates and constructed affine merge candidates, the video encoding apparatus may add a zero motion vector as a candidate.

The video encoding apparatus selects a merge candidate from the merge candidate list in terms of optimizing coding efficiency, and determines a merge index that indicates the merge candidate. The video encoding apparatus uses the selected merge candidate to perform an affine motion prediction on the target block. When the merge candidate is composed of two control point motion vectors, an affine motion prediction is performed by using a four-parameter affine model. On the other hand, when the merge candidate is composed of three control point motion vectors, an affine motion prediction is performed by using a six-parameter affine model. The video encoding apparatus encodes and signals the merge index to the video decoding apparatus.

The video decoding apparatus decodes the merge index. The inter predictor 544 of the video decoding apparatus constructs a merge candidate list in the same manner as the video encoding apparatus does, and performs affine motion prediction by using control point motion vectors corresponding to the merge candidates indicated by the merge index.

As another example, in the affine AMVP mode, from the perspective of coding efficiency optimization, the inter predictor 124 of the video encoding apparatus determines the type of the affine model and its resultant actual control point motion vectors for the target block. The video encoding apparatus calculates the MVD for each control point, which is the difference between the actual control point motion vector and each control point's MVP that is control point motion vector predictor, and then encodes the MVD at each control point. To derive each control point motion vector predictor, the inter predictor 124 constructs a list of a predefined number, e.g., 2 of affine AMVP candidates. When the target block is of the 4-parameter type, the affine AMVP candidates included in the list are each composed of a pair of two control point motion vectors. On the other hand, when the target block is of the 6-parameter type, the affine AMVP candidates included in the list are each composed of a pair of three control point motion vectors.

Hereinafter, the method of constructing a candidate list in affine AMVP mode is described. The affine AMVP candidate list may be derived in a manner similar to the method of constructing the affine merge candidate list described above.

The video encoding apparatus checks whether the reference picture of the inherited affine AMVP candidate is the same as the reference picture of the current block. Here, the inherited affine AMVP candidate may be a block predicted in affine mode among the neighboring blocks A0, A1, B0, B1, and B2 of the target block shown in FIG. 4, as in the affine merge mode described above.

If the reference picture of the inherited affine AMVP candidate is the same as the reference picture of the current block, the video encoding apparatus adds the inherited affine AMVP candidate.

On the other hand, if the reference picture of the inherited affine AMVP candidate is not the same as the reference picture of the current block, the video encoding apparatus checks whether the reference pictures of all CPMVs (control point motion vectors) of the constructed affine AMVP candidate are the same as the reference picture of the current block. Here, all CPMVs of the constructed affine AMVP candidate may be derived from the motion vectors of the neighboring samples shown in FIG. 6, as in the affine merge mode described above. If the reference picture of all CPMVs of the constructed affine AMVP candidate is the same as the reference picture of the current block, the video encoding apparatus adds such a constructed affine AMVP candidate.

At this point, the affine model type of the target block needs to be considered. If the affine model type of the target block is a 4-parameter type, the video encoding apparatus derives two control point motion vectors that are the top-left corner and top-right corner control point motion vectors of the target block by using the affine model of the neighboring block. If the affine model type of the target block is a 6-parameter type, three control point motion vectors of the target block's top-left, top-right, and bottom-left control point motion vectors are derived by using the affine model of the neighboring blocks.

If the reference pictures of all CPMVPs are not the same as the reference picture of the current block, the video encoding apparatus adds a translational motion vector as an affine AMVP candidate.

If the candidate list cannot be filled up, i.e., the preset candidate number cannot be filled even with the above processes, the video encoding apparatus adds a zero motion vector as an affine AMVP candidate.

The video encoding apparatus selects one candidate from the affine AMVP list and determines the candidate index indicating the selected candidate. At this time, each control point motion vector of the selected candidate corresponds to each control point motion vector predictor. From the perspective of coding efficiency optimization, the video encoding apparatus determines the actual control point motion vector for each control point of the target block, and then calculates the MVD between the actual control point motion vector and the control point motion vector predictor. The video encoding apparatus encodes the target block's affine model type, candidate index, and the MVD at each control point, and signals them to the video decoding apparatus.

The video decoding apparatus decodes the affine model type, candidate index, and MVD at each control point. The inter predictor 544 of the video decoding apparatus generates an affine AMVP list in the same manner as the video encoding apparatus does and selects a candidate indicated by the candidate index within the affine AMVP list. The video decoding apparatus sums each control point motion vector predictor of the selected candidate and its corresponding MVD to reconstruct the motion vector at each control point. The video decoding apparatus performs affine motion prediction by using the reconstructed control point motion vectors.

The following embodiments are described with a focus on the video decoding apparatus, but they may be implemented in the same or similar manner in the video encoding apparatus.

### II. Local Illumination Compensation (LIC)

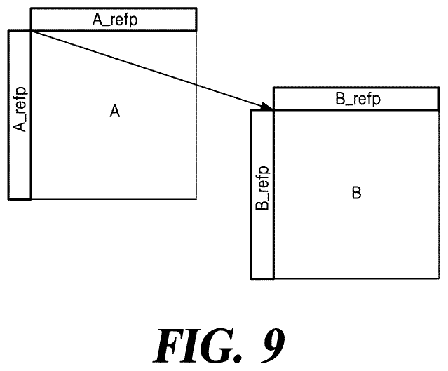

FIG. 9 is a diagram of an example local illumination compensation.

To increase the prediction efficiency of the current block, local illumination compensation performs illumination compensation according to changes in the video capturing environment. To effectively perform local illumination compensation, the video decoding apparatus derives parameters representing the linear relation between the current block A's neighboring reference pixels (A_refp) and the reference block B's neighboring reference pixels (B_refp). For example, the parameters of the linear relation may be derived based on the linear least square method. The video decoding apparatus uses the derived parameters of the linear relation to perform local illumination compensation of the current block A based on the reference block B, as shown in Equation 3.

Pred[x]=α·p[x]+β [Equation 3]

In Equation 3, α and β are parameters of the linear relation, representing a slope and an offset, respectively. p[x] represents a pixel in the reference block, and Pred[x] represents a predicted pixel in the current block subjected to an application of local illumination compensation.

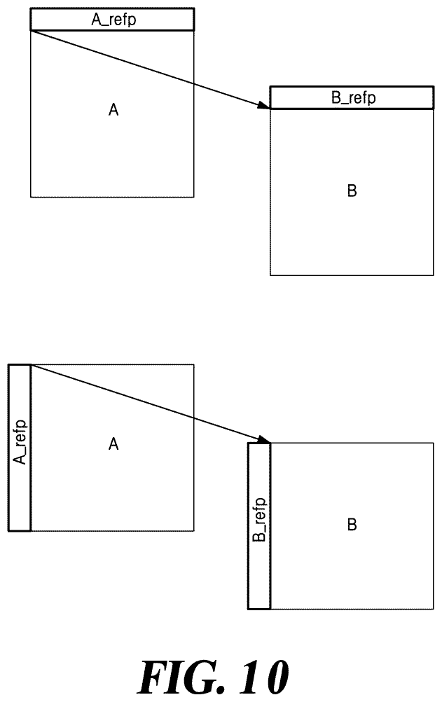

As mentioned above, local illumination compensation is applied to the current block, and the linear relation is derived based on the reference block B's neighboring reference pixels (B_refp) and the current block A's neighboring reference pixels (A_refp). In this case, when there are no available pixels among the reference block B's neighboring reference pixels, i.e., when no B_refp exists, no local illumination compensation may be performed on the current block. When pixels B_refp do not exist in both the left and top of reference block B but exist in some of the top or left side, local illumination compensation may be performed by using the pixels that exist, as illustrated in FIG. 10.

As an example, the video decoding apparatus may derive a linear relation by using only some of the pixels corresponding to A_refp and B_refp. For example, if the sizes of blocks A and B are 16×16, A_refp is typically composed of 32 pixels, and B_refp may also be composed of 32 pixels. In the examples of FIGS. 9 and 10, the video decoding apparatus extracts or downsamples pixels at specific positions to generate candidate pixels corresponding to A_refp and B_refp, and uses some of the candidate pixels to derive the parameters of the linear relation. Thereafter, the video decoding apparatus may use the derived linear relation to perform local illumination compensation and thereby generate a prediction block of the current block.

As another example, A_refp and B_refp may be limited to pixels at integer positions. For example, when the predicted reference block based on the motion vector does not exist at an integer position, the video decoding apparatus performs inter prediction of the current block by calculating the values of the pixels at fractional positions by applying filtering to the integer position pixel values of the reference video. At this time, the neighboring reference pixels B_refp of the reference block may also be values of pixels at positions calculated according to the filtering. However, depending on the embodiment, the video decoding apparatus may go without performing filtering to set the nearest integer pixels as B_refp, and use the set B_refp as neighboring reference pixels for linear modeling.

In yet another example, A_refp and B_refp may be composed of multiple pixel lines in addition to a single pixel line. For example, when the sizes of blocks A and B are 16×16, A_refp and B_refp may be in the form of 16×N+M×16. Namely, A_refp and B_refp may be composed of 16×N+16×M pixels, including the form of ‘block width×multiple pixel lines’ and ‘multiple pixel lines× block height’. Here, N represents multiple pixel lines on the top side of the block, and M represents multiple pixel lines on the left side of the block. As another example, the embodiment using the above-described multiple pixel lines and the embodiment using only some of the candidate pixels may be combined. Namely, the video decoding apparatus sets the pixels on the multiple pixel lines as candidates and uses some of the candidate pixels to derive the parameters of the linear relation.

The parameters a and B of the linear relation used in local illumination compensation are calculated identically in the video encoding apparatus and the video decoding apparatus. Therefore, the video encoding apparatus may not separately transmit the parameters of the linear relation to the video decoding apparatus. As another example, the linear relation may be defined by calculating only β with α fixed to a specific non-zero value.

### III. Applying Local Illumination Compensation to Affine Model-Based Prediction

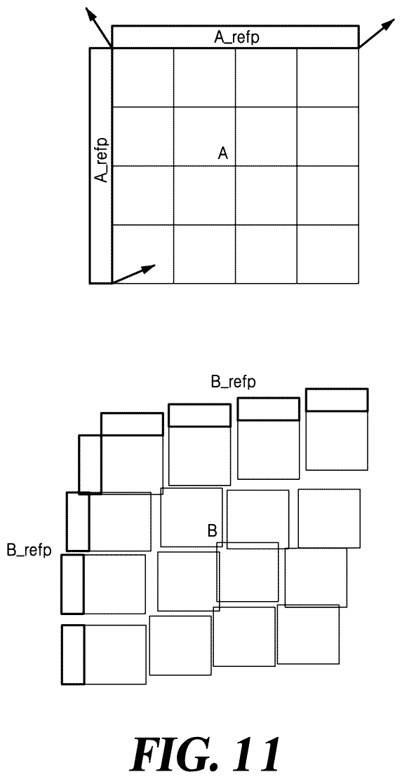

FIG. 11 is a diagram illustrating local illumination compensation in affine model-based prediction, according to at least one embodiment of the present disclosure.

As described above, in affine model-based prediction, the video decoding apparatus generates as the current block's motion vector a control point motion vector at a position corresponding to the vertex of the current block. The video decoding apparatus uses the generated control point motion vectors to model the geometric transform relationship between the current block and its prediction block, and then performs prediction based on the modeled affine model. At this time, the respective pixel values of the current block may be predicted by using the control point motion vectors and the respective pixel positions.

Depending on the embodiment, to reduce the computational complexity, the video decoding apparatus may perform prediction by units of arbitrary blocks, i.e., subblocks that use each control point motion vector as the center vector. The video decoding apparatus divides the current block into arbitrary blocks and performs prediction for each arbitrary block. At this time, each arbitrary block has a separate motion vector. Therefore, when applying local illumination compensation, the video decoding apparatus takes reference block B's neighboring reference pixels B_refp and establishes their corresponding relationship with neighboring reference pixels of each arbitrary block to derive parameters of the linear relation. As illustrated in FIG. 11, the neighboring reference pixels of the arbitrary blocks located at the top and left are used to derive the parameters of the linear relation.

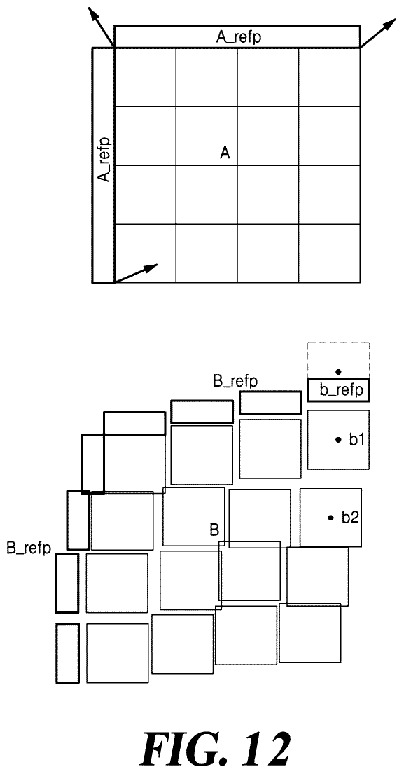

Meanwhile, B_refp may be a reference pixel located at a position taking account of the control point motion vector of the current block. For example, as illustrated in FIG. 12, B_refp is not located at an adjacent position in the video coordinate system of the arbitrary blocks, but at an adjacent position calculated based on the control point motion vector.

The video decoding apparatus may calculate B_refp for arbitrary blocks of B by using a method of extrapolating center vectors for arbitrary blocks of B. For example, in the example of FIG. 12, b_refp among B_refp may be calculated as follows. For example, the video decoding apparatus may extrapolate the center vectors of blocks b1 and b2 to infer the center vector of an arbitrary block containing b_refp, and derive b_refp from the arbitrary block having the inferred center vector. In a similar manner, reference pixels may be derived for other parts of B_refp shown in FIG. 12. After deriving B_refp in their entirety as described above, the video decoding apparatus may perform the remaining processes for local illumination compensation.

Meanwhile, the video decoding apparatus may reflect the application of local illumination compensation in in-loop filtering. For example, when determining the filtering intensity at the boundary between two adjacent blocks, the video decoding apparatus may use the parameters α and β of the linear relation. For example, if (i) local illumination compensation is applied to two blocks containing the target pixels for in-loop processing and (ii) no a values of the two blocks are 1 and no β values of the two blocks are 0, then even if the reference images of the two blocks are the same, the video decoding apparatus may determine the parameter BS that determines the filtering intensity to be 1 and apply filtering to the boundary between the two blocks. Alternatively, if the a values of the two blocks containing the target pixels for filtering are different, the video decoding apparatus may determine BS to be 1 and apply filtering to the boundary between the two blocks.

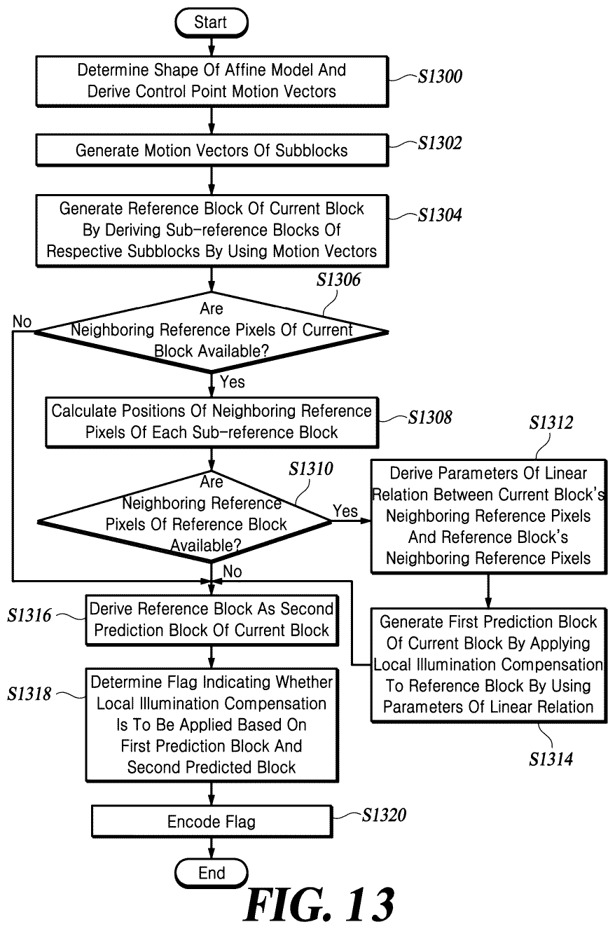

Hereinafter, by using the illustrations in FIGS. 13 to 15, methods of applying local illumination compensation in affine model-based prediction are described.

FIG. 13 is a flowchart of a method of encoding a current block by the video encoding apparatus, according to at least one embodiment of the present disclosure.

The video encoding apparatus determines the shape of the affine model of the current block and derives the control point motion vectors (S1300). In terms of rate distortion optimization, the video encoding apparatus may determine the shape of the affine model.

The video encoding apparatus generates motion vectors of subblocks by using the shape of the affine model and the control point motion vectors (S1302). Here, the subblocks represent arbitrary blocks divided from the current block.

The video encoding apparatus uses the motion vectors to derive sub-reference blocks of the respective subblocks and thereby generates a reference block of the current block (S1304).

The video encoding apparatus performs the following steps to check the availability status of neighboring reference pixels used for linear modeling for local illumination compensation. At this time, availability may include not only the existence of already decoded neighboring reference pixels (A_refp and B_refp), but also whether neighboring reference pixels can be used for an application of local illumination compensation to the current block.

The video encoding apparatus checks the availability of neighboring reference pixels of the current block at the top and left of the current block (S1306).

If the neighboring reference pixels (A_refp) of the current block are available (Yes in S1306), the video encoding apparatus performs the following steps.

The video encoding apparatus takes the top sub-reference blocks and left sub-reference blocks of the reference block and calculates the positions of the neighboring reference pixels of each top or left sub-reference block (S1308).

The video encoding apparatus sets the center vectors of the sub-reference blocks to the motion vectors corresponding to the sub-reference blocks of the reference block. The video encoding apparatus extrapolates the center vectors to infer center vectors of neighboring blocks of each sub-reference block. The video encoding apparatus derives the positions of right or bottom pixels of neighboring blocks having inferred center vectors as positions of neighboring reference pixels of each sub-reference block.

The video encoding apparatus checks the availability, at the calculated positions, of the neighboring reference pixels of each sub-reference block to check the availability of the neighboring reference pixels of the reference block (S1310).

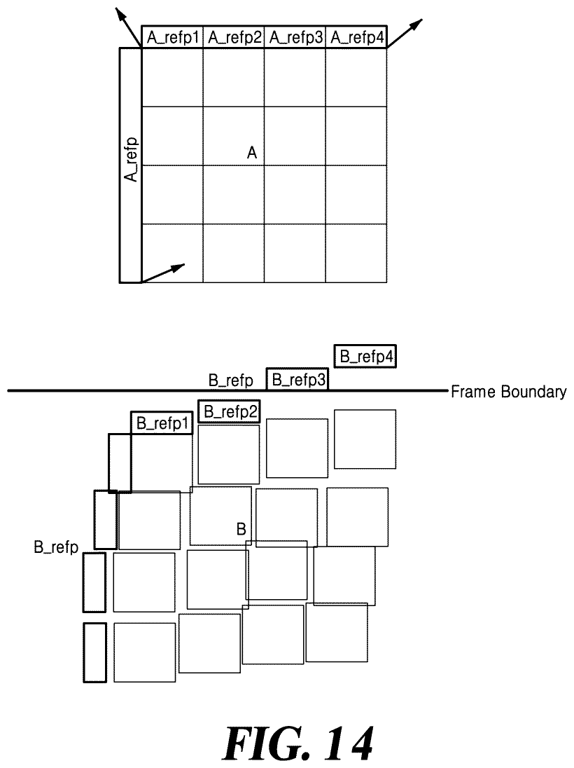

For example, as illustrated in FIG. 14, if some of the neighboring reference pixels (B_refp) of the reference block are available (Yes in S1310), the video encoding apparatus may use the available pixels B_refp1 and B_refp2 among the left pixels B_refp and the top pixels B_refp. Alternatively, the video encoding apparatus may use the left pixels B_refp without using all of the top pixels B_refp.

If all or some of the neighboring reference pixels (B_refp) of the reference block are available (Yes in S1310), the video encoding apparatus performs the following steps.

The video encoding apparatus derives parameters of the linear relation between the neighboring reference pixels of the current block and the neighboring reference pixels of the reference block (S1312).

For example, the video encoding apparatus selects pixels used for linear modeling from among the neighboring reference pixels (A_refp) of the current block and the neighboring reference pixels (B_refp) of the reference block, and then uses the selected reference pixels to calculate the parameters (a and B) of the linear relation. The pixels used to calculate the parameters may be all or some of the neighboring reference pixels (A_refp) of the current block and the neighboring reference pixels (B_refp) of the reference block. To derive the parameters, this case uses the neighboring reference pixels of the reference block, which correspond in position to the neighboring reference pixels of the current block. As another example, filtering may be applied to the neighboring reference pixels (A_refp) of the current block and the neighboring reference pixels (B_refp) of the reference block, and the filtered pixels may be used to derive the parameters.

The video encoding apparatus uses the parameters of the linear relation to apply local illumination compensation to the reference block and thereby generates a first prediction block of the current block (S1314).

The video encoding apparatus derives the reference block as a second prediction block of the current block (S1316).

On the other hand, if the neighboring reference pixels A_refp of the current block are not available (No in S1306) or the neighboring reference pixels B_refp of the reference block are not available (No in S1310), the video encoding apparatus derives the reference block as the second prediction block of the current block. For example, the video decoding apparatus generates the second prediction block of the current block without performing operations related to local illumination compensation. Or, the video decoding apparatus skips the process of deriving the parameters of the linear relation. Namely, the video decoding apparatus generates the second prediction block of the current block by assigning α to 1 and β to 0, thereby skipping local illumination compensation.

The video encoding apparatus determines a flag indicating whether local illumination compensation is to be applied, based on the first prediction block and the second prediction block (S1318).

In terms of rate distortion optimization, the video encoding apparatus may determine the flag indicating whether local illumination compensation is to be applied. For example, if the first prediction block is optimal, the video encoding apparatus sets the flag to true. On the other hand, if the second prediction block is optimal, the video encoding apparatus sets the flag to false.

The video encoding apparatus encodes the flag (S1320).

For example, the video encoding apparatus may determine whether local illumination compensation is to be applied to an image or slice. The flag indicating whether local illumination compensation is to be applied may be transmitted by using high level syntax, or using block group-level syntax such as CTU or CU, or block-level syntax.

Depending on the value of the flag indicating whether local illumination compensation is to be applied, the video encoding apparatus subtracts the first prediction block or the second prediction block from the current block to generate a residual block. The video encoding apparatus transforms/quantizes the residual block to generate and encode quantized transform coefficients.

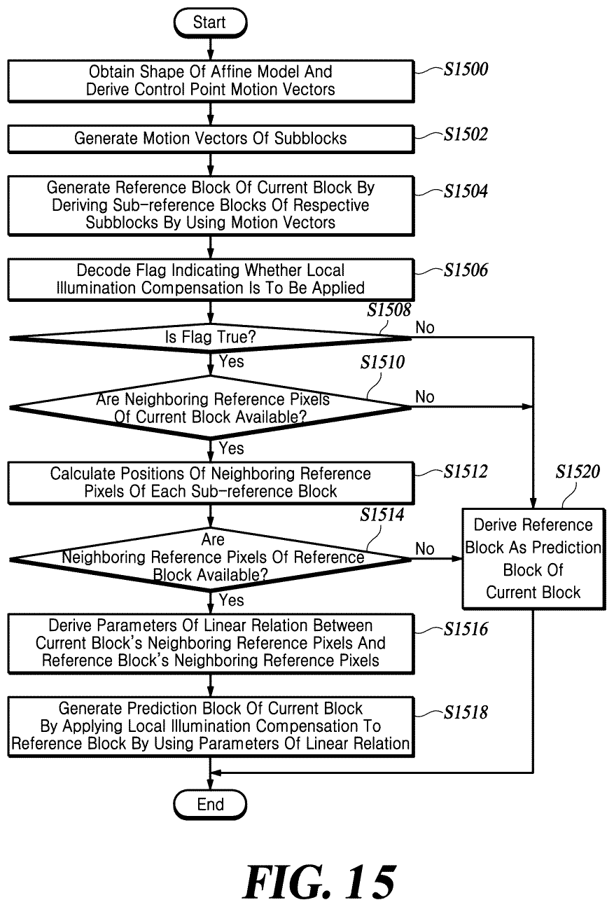

FIG. 15 is a flowchart of a method of reconstructing a current block by the video decoding apparatus, according to at least one embodiment of the present disclosure.

The video decoding apparatus obtains the shape of the affine model of the current block and derives the control point motion vectors (S1500).

The video decoding apparatus uses the shape of the affine model and control point motion vectors to generate motion vectors of subblocks (S1502). Here, the subblocks represent arbitrary blocks partitioned from the current block.

The video decoding apparatus uses motion vectors to derive sub-reference blocks of subblocks and thereby generates a reference block of the current block (S1504).

The video decoding apparatus decodes from the bitstream a flag indicating whether local illumination compensation is to be applied (S1506).

For example, the video decoding apparatus may determine whether local illumination compensation is to be applied to an image or slice. The flag indicating whether local illumination compensation is to be applied may be transmitted by using high level syntax, or using block group-level syntax such as CTU or CU, or block-level syntax.

The video decoding apparatus checks the flag (S1508).

If the flag indicating whether local illumination compensation is to be applied is true (Yes in S1508), the video decoding apparatus performs the following steps to check the availability status of neighboring reference pixels used for linear modeling for local illumination compensation. At this point, the availability may include not only the existence of already decoded neighboring reference pixels (A_refp and B_refp), but also whether neighboring reference pixels can be used for an application of local illumination compensation to the current block.

The video decoding apparatus checks the availability of neighboring reference pixels of the current block at the top and left of the current block (S1510).

When the neighboring reference pixels (A_refp) of the current block are available (Yes in S1510), the video decoding apparatus performs the following steps.

The video decoding apparatus takes the top sub-reference blocks and left sub-reference blocks of the reference block and determines the positions of the neighboring reference pixels of each top or left sub-reference block (S1512).

The video decoding apparatus sets center vectors of sub-reference blocks to motion vectors corresponding to the sub-reference blocks of the reference block. The video decoding apparatus extrapolates the center vectors to infer the center vectors of neighboring blocks of each sub-reference block. The video decoding apparatus derives the positions of the right or bottom pixels of the neighboring blocks having the inferred center vectors as the positions of the neighboring reference pixels of each sub-reference block.

The video decoding apparatus checks the availability, at the calculated positions, of the neighboring reference pixels of each sub-reference block to check the availability of the neighboring reference pixels of the reference block (S1514).

For example, as illustrated in FIG. 14, if some of the neighboring reference pixels (B_refp) of the reference block are available (Yes in S1514), the video decoding apparatus may use the available pixels B_refp1 and B_refp2 among the left pixels B_refp and the top pixels B_refp. Alternatively, the video decoding apparatus may use the left pixels B_refp without using all of the top pixels B_refp.

If all or some of the neighboring reference pixels (B_refp) of the reference block are available (Yes in S1514), the video decoding apparatus performs the following steps.

The video decoding apparatus derives the parameters of the linear relation between the neighboring reference pixels of the current block and the neighboring reference pixels of the reference block (S1516).

For example, the video decoding apparatus selects, from the neighboring reference pixels (A_refp) of the current block and the neighboring reference pixels (B_refp) of the reference block, such pixels that are used for linear modeling, and then uses the selected pixels to calculate the parameters (a and B) of the linear relation. The pixels used to calculate the parameters may be all or some of the neighboring reference pixels (A_refp) of the current block and the neighboring reference pixels (B_refp) of the reference block. To derive the parameters, this case uses the neighboring reference pixels of the reference block, which correspond in position to the neighboring reference pixels of the current block. As another example, filtering may be applied to the neighboring reference pixels (A_refp) of the current block and the neighboring reference pixels (B_refp) of the reference block, and the filtered pixels may be used to derive the parameters.

The video decoding apparatus uses the parameters of the linear relation to apply local illumination compensation to the reference block and thereby generates a prediction block of the current block (S1518).

On the other hand, if the flag indicating whether local illumination compensation is to be applied is false (No in S1508), or the neighboring reference pixels A_refp of the current block are unavailable (No in S1510), or the neighboring reference pixels B_refp of the reference block are unavailable (No in S1514), then the video decoding apparatus derives the reference block as the prediction block of the current block (S1520).

An another example, if some of the neighboring reference pixels (B_refp) of the reference block are available, the video decoding apparatus also derives the reference block as the prediction block of the current block.

For example, the video decoding apparatus generates the prediction block of the current block without performing operations related to local illumination compensation. Alternatively, the video decoding apparatus skips the process of deriving the parameters of the linear relation. Namely, the video decoding apparatus assigns a to 1 and β to 0 to skip local illumination compensation, and generates the prediction block of the current block.

The video decoding apparatus decodes from the bitstream quantized transform coefficients, and inverse quantizes/inverse transforms the quantized transform coefficients to reconstruct the residual block. The video decoding apparatus sums the prediction block and the residual block to generate the reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
155: entropy encoder
510: entropy decoder
544: inter predictor

### CROSS-REFERENCE TO RELATED APPLICATIONS

This application claims priority to and the benefit of Korean Patent Application No. 10-2023-0063322 filed on May 16, 2023, and Korean Patent Application No. 10-2024-0037141, filed on Mar. 18, 2024, the entire contents of each of which are incorporated herein by reference.

What is claimed is:

1. A method of reconstructing a current block by a video decoding apparatus, the method comprising:
obtaining a shape of an affine model of the current block and deriving control point motion vectors;
generating, by using the shape of the affine model and the control point motion vectors, motion vectors of subblocks partitioned from the current block;
generating a reference block of the current block by deriving sub-reference blocks of the subblocks by using the motion vectors; and
checking availability of neighboring reference pixels of the current block at a top side and a left side of the current block,
wherein the method further comprises, when the neighboring reference pixels of the current block are available:
calculating, related to top sub-reference blocks and left sub-reference blocks of the reference block, positions of neighboring reference pixels of each top or left sub-reference block; and
checking availability of neighboring reference pixels of the reference block by checking availability, at the positions calculated, of the neighboring reference pixels of each top or left sub-reference block, and
wherein the method further comprises, when the neighboring reference pixels of the reference block are available in whole or in part:
deriving parameters of a linear relation between the neighboring reference pixels of the current block and the neighboring reference pixels of the reference block; and
generating a prediction block of the current block by applying local illumination compensation to the reference block by using the parameters of the linear relation.

2. The method of claim 1, further comprising:
decoding, from a bitstream, a flag indicative of whether the local illumination compensation is to be applied; and
checking the flag, and when the flag is true, the method proceeds with checking the availability of the neighboring reference pixels of the current block.

3. The method of claim 1, further comprising:
when the flag is false, deriving the reference block as a prediction block of the current block.

4. The method of claim 1, further comprising, when the neighboring reference pixels of the current block are not available or when the neighboring reference pixels of the reference block are not available:
deriving the reference block as a prediction block of the current block.

5. The method of claim 1, wherein calculating the positions of the neighboring reference pixels of each sub-reference block comprises:
limiting the positions of the neighboring reference pixels to integer positions without filtering based on the motion vectors.

6. The method of claim 1, wherein the neighboring reference pixels of the current block and the neighboring reference pixels of the reference block comprise:
a plurality of pixel lines.

7. The method of claim 1, wherein calculating the positions of the neighboring reference pixels of each top or left sub-reference block comprises:
setting center vectors of the sub-reference blocks with motion vectors corresponding to sub-reference blocks of the reference block;
inferring, by extrapolating the center vectors, a center vector of a neighboring block of each top or left sub-reference block; and
deriving positions of right or bottom pixels of the neighboring block having the inferred center vector as the positions of the neighboring reference pixels of each top or left sub-reference block.

8. The method of claim 1, wherein deriving the parameters of the linear relation comprises:
deriving the parameters by applying a linear least square method to the neighboring reference pixels of the current block and the neighboring reference pixels of the reference block.

9. The method of claim 1, wherein deriving the parameters of the linear relation comprises:
using all or some of the neighboring reference pixels of the current block and all or some of the neighboring reference pixels of the reference block, wherein the neighboring reference pixels of the reference block corresponding to positions of the neighboring reference pixels of the current block are used.

10. The method of claim 1, further comprising:
applying in-loop filtering to a boundary between the prediction block with the local illumination compensation applied and an adjacent block to the prediction block,
wherein applying the in-loop filtering comprises:
determining a filtering intensity at the boundary by using parameters of linear relations between the prediction block and the adjacent block.

11. A method of encoding a current block by a video encoding apparatus, the method comprising:
determining a shape of an affine model of the current block and deriving control point motion vectors;
generating, by using the affine model and the control point motion vectors, motion vectors of subblocks partitioned from the current block;
generating a reference block of the current block by deriving sub-reference blocks of the subblocks by using the motion vectors; and
checking availability of neighboring reference pixels of the current block at a top side and a left side of the current block,
wherein the method further comprises, when the neighboring reference pixels of the current block are available:
calculating, related to top sub-reference blocks and left sub-reference blocks of the reference block, positions of neighboring reference pixels of each top or left sub-reference block; and
checking availability of neighboring reference pixels of the reference block by checking availability, at the positions calculated, of the neighboring reference pixels of each top or left sub-reference block, and
wherein the method further comprises, when the neighboring reference pixels of the reference block are available in whole or in part:
deriving parameters of a linear relation between the neighboring reference pixels of the current block and the neighboring reference pixels of the reference block; and
generating a first prediction block of the current block by applying local illumination compensation to the reference block by using the parameters of the linear relation.

12. The method of claim 11, further comprising:
deriving the reference block as a second prediction block of the current block;
determining, based on the first prediction block and the second prediction block, a flag indicative of whether the local illumination compensation is to be applied; and
encoding the flag.

13. The method of claim 11, further comprising, when the neighboring reference pixels of the current block are not available or when the neighboring reference pixels of the reference block are not available:
skipping generating the first prediction block.

14. A computer-readable recording medium storing a bitstream generated by a video encoding method, wherein the video encoding method comprises:
determining a shape of an affine model of a current block and deriving control point motion vectors;
generating, by using the affine model and the control point motion vectors, motion vectors of subblocks partitioned from the current block;
generating a reference block of the current block by deriving sub-reference blocks of the subblocks by using the motion vectors; and
checking availability of neighboring reference pixels of the current block at a top side and a left side of the current block,
wherein the video encoding method further comprises, when the neighboring reference pixels of the current block are available:
calculating, related to top sub-reference blocks and left sub-reference blocks of the reference block, positions of neighboring reference pixels of each top or left sub-reference block; and
checking availability of neighboring reference pixels of the reference block by checking availability, at the positions calculated, of the neighboring reference pixels of each top or left sub-reference block, and
wherein the video encoding method further comprises, when the neighboring reference pixels of the reference block are available in whole or in part:
deriving parameters of a linear relation between the neighboring reference pixels of the current block and the neighboring reference pixels of the reference block; and
generating a prediction block of the current block by applying local illumination compensation to the reference block by using the parameters of the linear relation.
